(19) United States
(12) Patent Application Publication
(10) Pub. No.: US 2022/0202266 A1
(43) Pub. Date: Jun. 30, 2022

(54) AUTONOMOUS MOBILE SYSTEM, AUTONOMOUS MOBILE METHOD, AND AUTONOMOUS MOBILE PROGRAM

(71) Applicant: TOYOTA JIDOSHA KABUSHIKI KAISHA, Toyota-shi Aichi-ken (JP)

(72) Inventors: Shiro Oda, Anjo-shi Aichi-ken (JP); Tetsuya Taira, Nagakute-shi Aichi-ken (JP); Satoshi Toyoshima, Okazaki-shi Aichi-ken (JP); Yuta Watanabe, Toyota-shi Aichi-ken (JP); Takeshi Matsui, Nisshin-shi Aichi-ken (JP); Takayoshi Nasu, Okazaki-shi Aichi-ken (JP); Kei Yoshikawa, Nagoya-shi Aichi-ken (JP); Yusuke Ota, Nagakute-shi Aichi-ken (JP); Yutaro Ishida, Toyota-shi Aichi-ken (JP); Yuji Onuma, Nagoya-shi Aichi-ken (JP); Kyosuke Arai, Toyota-shi Aichi-ken (JP)

(73) Assignee: TOYOTA JIDOSHA KABUSHIKI KAISHA, Toyota-shi Aichi-ken (JP)

(21) Appl. No.: 17/509,350

(22) Filed: Oct. 25, 2021

(30) Foreign Application Priority Data
Dec. 24, 2020 (JP) 2020-215175

(51) Int. Cl. A47L 11/40; G05D 1/02

(52) U.S. Cl. CPC A47L 11/4011; G05D 2201/0203; A47L 2201/04; G05D 1/0214

(57) ABSTRACT

An autonomous mobile system according to an embodiment is an autonomous mobile system that autonomously moves in a facility provided with an area set as a clean area and an area set as an unclean area. The autonomous mobile system searches for a route along which the autonomous mobile system moves based on a rule of entry to the clean area and the unclean area. In the rule, when the autonomous mobile system is associated with a cleanliness flag, the autonomous mobile system is allowed to enter the clean area and prohibited from entering the unclean area, and when the autonomous mobile system is associated with an uncleanliness flag, the autonomous mobile system is allowed to enter the unclean area and prohibited from entering the clean area.

### CROSS-REFERENCE TO RELATED APPLICATION

This application claims priority to Japanese Patent Application No. 2020-215175 filed on Dec. 24, 2020, incorporated herein by reference in its entirety.

### BACKGROUND

### 1. Technical Field

The present disclosure relates to an autonomous mobile system, an autonomous mobile method, and an autonomous mobile program.

### 2. Description of Related Art

Japanese Patent No. 6470322 (JP 6470322 B) describes that traveling of a transportation robot and route generation are controlled.

### SUMMARY

For example, there is a demand for avoiding that an autonomous mobile device loaded with drugs, blood, etc. to be administered to a patient and an autonomous mobile device loaded with garbage are placed close to each other, such as being placed in the same elevator.

The present disclosure has been made to solve the issue above, and provides an autonomous mobile system, an autonomous mobile method, and an autonomous mobile program capable of improving the viewpoint of health and hygiene.

An autonomous mobile system according to an embodiment is an autonomous mobile system that autonomously moves in a facility provided with an area set as a clean area and an area set as an unclean area. When the autonomous mobile system is associated with a cleanliness flag, the autonomous mobile system is allowed to enter the clean area and prohibited from entering the unclean area. When the autonomous mobile system is associated with an uncleanliness flag, the autonomous mobile system is allowed to enter the unclean area and prohibited from entering the clean area. The autonomous mobile system searches for a route based on a rule of entry to the clean area and the unclean area, and moves based on the rule. With this configuration, the viewpoint of health and hygiene can be improved.

In the above autonomous mobile system, the facility may be provided with an elevator; and when the autonomous mobile system is associated with the cleanliness flag, the autonomous mobile system may be prohibited from being placed in a car of the elevator with another autonomous mobile system associated with the uncleanliness flag. With this configuration, the viewpoint of health and hygiene of the clean autonomous mobile system in the elevator can be improved.

In the above autonomous mobile system, the facility may be provided with an elevator; and an inside of a car of the elevator in which the autonomous mobile system associated with the cleanliness flag has been placed may be set as the clean area for a predetermined period. With this configuration, the viewpoint of health and hygiene of the clean area in the elevator can be improved.

In the above autonomous mobile system, the facility may be provided with a standby area where the autonomous mobile system stops and waits; and when the autonomous mobile system is associated with the cleanliness flag, the autonomous mobile system may be prohibited from waiting in the same standby area as another autonomous mobile system associated with the uncleanliness flag. With this configuration, the viewpoint of health and hygiene of the clean autonomous mobile system in the standby area can be improved.

In the above autonomous mobile system, the facility may be provided with a standby area where the autonomous mobile system stops and waits; and the standby area where the autonomous mobile system associated with the cleanliness flag has waited may be set as the clean area for a predetermined period. With this configuration, the viewpoint of health and hygiene of the clean area in the standby area can be improved.

In the above autonomous mobile system, when the autonomous mobile system is associated with the cleanliness flag, the autonomous mobile system may move away from another autonomous mobile system associated with the uncleanliness flag by a predetermined distance or more. With this configuration, the viewpoint of health and hygiene for movement in the facility can be improved.

In the above autonomous mobile system, when the autonomous mobile system is associated with a general-purpose flag, the autonomous mobile system may be allowed to enter the clean area and allowed to enter the unclean area. With such a configuration, the traveling efficiency of the autonomous mobile system can be improved.

In the above autonomous mobile system, a predetermined area in the facility may be set as the clean area or the unclean area for a predetermined time. With this configuration, the efficiency of use in the facility can be improved.

An autonomous mobile system according to an embodiment includes: an autonomous mobile device that autonomously moves in a facility provided with an area set as a clean area and an area set as an unclean area; and a server device that transmits and receives traveling information to and from the autonomous mobile device. When the autonomous mobile system is associated with a cleanliness flag, the autonomous mobile system is allowed to enter the clean area and prohibited from entering the unclean area. When the autonomous mobile system is associated with an uncleanliness flag, the autonomous mobile system is allowed to enter the unclean area and prohibited from entering the clean area. The server device searches for a route along which the autonomous mobile device moves, based on a rule of entry to the clean area and the unclean area. The autonomous mobile device moves based on the rule. With this configuration, the viewpoint of health and hygiene can be improved.

In the above autonomous mobile system, the facility may be provided with an elevator, and when the autonomous mobile device is associated with the cleanliness flag, the autonomous mobile device may be prohibited from being placed in a car of the elevator with another autonomous mobile device associated with the uncleanliness flag. The viewpoint of health and hygiene of the clean autonomous mobile device in the elevator can be improved.

In the above autonomous mobile system, the facility may be provided with an elevator, and the server device may set an inside of a car of the elevator in which the autonomous mobile device associated with the cleanliness flag has been placed as the clean area for a predetermined period. With this configuration, the viewpoint of health and hygiene of the clean area in the elevator can be improved.

In the above autonomous mobile system, the facility may be provided with a standby area where the autonomous mobile device stops and waits, and when the autonomous mobile device is associated with the cleanliness flag, the autonomous mobile device may be prohibited from waiting in the same standby area as another autonomous mobile device associated with the uncleanliness flag. With this configuration, the viewpoint of health and hygiene of the clean autonomous mobile device in the standby area can be improved.

In the above autonomous mobile system, the facility may be provided with a standby area where the autonomous mobile device stops and waits, and the server device may set the standby area where the autonomous mobile device associated with the cleanliness flag has waited as the clean area for a predetermined period. With this configuration, the viewpoint of health and hygiene of the clean area in the standby area can be improved.

In the above autonomous mobile system, the server device may cause the autonomous mobile device associated with the cleanliness flag to move away from another autonomous mobile device associated with the uncleanliness flag by a predetermined distance or more. With this configuration, the viewpoint of health and hygiene for movement in the facility can be improved.

In the above autonomous mobile system, when the autonomous mobile device is associated with a general-purpose flag, the autonomous mobile device may be allowed to enter the clean area and allowed to enter the unclean area. With this configuration, the traveling efficiency can further be improved.

In the above autonomous mobile system, the server device may set a predetermined area in the facility as the clean area or the unclean area for a predetermined time. With this configuration, the viewpoint of health and hygiene can be improved.

An autonomous mobile method according to the present embodiment is an autonomous mobile method for an autonomous mobile device that autonomously moves in a facility provided with an area set as a clean area and an area set as an unclean area, and includes: a step of associating the autonomous mobile device with a cleanliness flag or an uncleanliness flag; a step of searching for a route along which the autonomous mobile device moves based on a rule of entry to the clean area and the unclean area, the rule being a rule in which, when the autonomous mobile device is associated with the cleanliness flag, the autonomous mobile device is allowed to enter the clean area and prohibited from entering the unclean area, and when the autonomous mobile device is associated with the uncleanliness flag, the autonomous mobile device is allowed to enter the unclean area and prohibited from entering the clean area; and a step of moving based on the rule. With this configuration, the viewpoint of health and hygiene can be improved.

An autonomous mobile program according to the present embodiment is an autonomous mobile program for an autonomous mobile device that autonomously moves in a facility provided with an area set as a clean area and an area set as an unclean area, and causes a computer to: associate the autonomous mobile device with a cleanliness flag or an uncleanliness flag; search a route along which the autonomous mobile device moves based on a rule of entry to the clean area and the unclean area, the rule being a rule in which, when the autonomous mobile device is associated with the cleanliness flag, the autonomous mobile device is allowed to enter the clean area and prohibited from entering the unclean area, and when the autonomous mobile device is associated with the uncleanliness flag, the autonomous mobile device is allowed to enter the unclean area and prohibited from entering the clean area; and cause the autonomous mobile device to move based on the rule. With this configuration, the viewpoint of health and hygiene can be improved.

The present embodiment can provide an autonomous mobile system, an autonomous mobile method, and an autonomous mobile program capable of improving the viewpoint of health and hygiene.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating a mobile robot according to a first embodiment;

FIG. 2 is a perspective view illustrating the mobile robot according to the first embodiment;

FIG. 3 is a block diagram illustrating the mobile robot according to the first embodiment;

FIG. 4 is a plan view illustrating movement of the mobile robot in a facility according to the first embodiment;

FIG. 5 is a plan view illustrating movement of the mobile robot in the facility according to the first embodiment;

FIG. 6 is a flowchart illustrating an autonomous mobile method for the mobile robot in the facility according to the first embodiment;

FIG. 7 is a block diagram illustrating a server device according to a second embodiment; and

FIG. 8 is a sequence diagram illustrating the operation of the autonomous mobile system according to the second embodiment.

### DETAILED DESCRIPTION OF EMBODIMENTS

Hereinafter, the present disclosure will be described through embodiments of the disclosure, but the disclosures are not limited to the following embodiments. Moreover, not all of the configurations described in the embodiments are indispensable for solving the problem. For the sake of clarity, the following description and drawings have been omitted and simplified as appropriate. In each drawing, the same elements are designated by the same reference signs, and duplicate descriptions are omitted as necessary.

### First Embodiment

An autonomous mobile system according to a first embodiment will be described. In the present embodiment, the autonomous mobile system may be replaced with an autonomous mobile device, or the autonomous mobile device may be replaced with an autonomous mobile system. Further, the autonomous mobile system according to the present embodiment may include the autonomous mobile device. The autonomous mobile device autonomously moves in a predetermined facility. The autonomous mobile device may be, for example, a mobile robot that autonomously moves, or a transportation robot that autonomously moves to transport an object. Hereinafter, the mobile robot will be described as an example of the autonomous mobile device. The mobile robot will be described separately in “Structure of Mobile Robot” and “Operation of Mobile Robot”.

### Structure of Mobile Robot

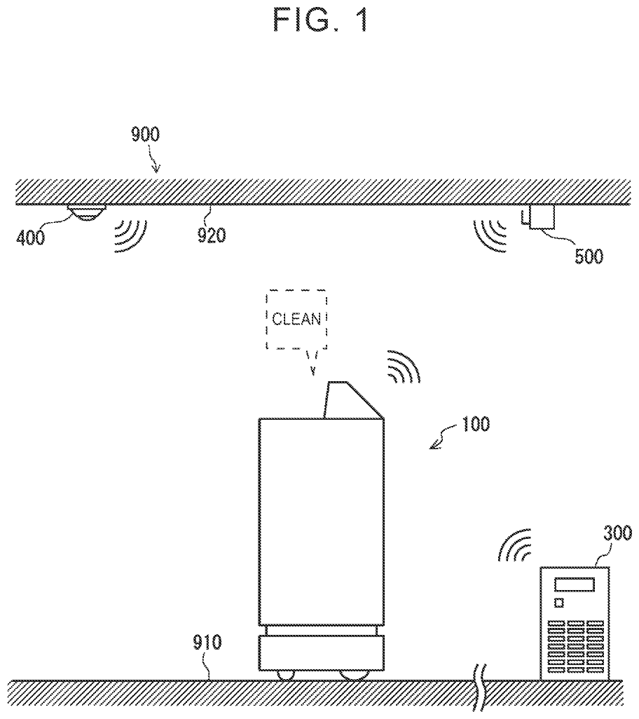

FIG. 1 is a schematic view illustrating a mobile robot according to the first embodiment. As shown in FIG. 1, a mobile robot 100 is an example of the autonomous mobile device that autonomously moves in a predetermined facility 900. The predetermined facility 900 is, for example, a hospital. The predetermined facility 900 is not limited to a hospital, and may be a hotel, a shopping mall, or the like as long as the mobile robot 100 can move autonomously in the predetermined facility 900.

The mobile robot 100 autonomously moves on a floor surface 910 in the facility 900. A facility camera 400 is fixed in the facility 900. For example, the facility camera 400 is fixed to a ceiling 920 of the facility 900, and captures images of surrounding areas of the facility camera 400 to generate image data. A plurality of the facility cameras 400 may be provided in the facility 900.

The mobile robot 100 and the facility camera 400 are connected to each other so as to be able to communicate with each other via information transmission techniques such as wireless communication. The mobile robot 100 and the facility camera 400 may be connected to each other so as to be able to directly communicate with each other, or may be connected to each other so as to be able to communicate with each other via an access point 500 and a server device 300. Therefore, the mobile robot 100 may acquire the image data directly from the facility camera 400, or may acquire the image data via the access point 500 and the server device 300.

The access point 500 is, for example, a wireless local area network (LAN) access point. The access point 500 is fixed in the facility 900 and acquires position information and traveling information from the mobile robot 100 located in the periphery of the access point 500. A plurality of the access points 500 may be provided in the facility 900.

A plurality of the mobile robots 100 may autonomously move in the facility 900. When the mobile robots 100 autonomously move, the mobile robots 100 may be connected to each other so as to be able to communicate with each other via information transmission techniques such as wireless communication. The mobile robots 100 may be connected to each other so as to be able to directly communicate with each other, or may be connected to each other so as to be able to communicate with each other via the access point 500 and the server device 300.

The information transmitted and received among the mobile robot 100, the server device 300, and another mobile robot 100 may include flag information which is associated with a plurality of areas in the facility 900 and the mobile robots 100. The flag information is, for example, information such as a cleanliness flag, an uncleanliness flag, and a general-purpose flag associated with cleanliness of the areas in the facility 900 and the cleanliness of objects transported by the mobile robot 100. The details of the flag information will be described later.

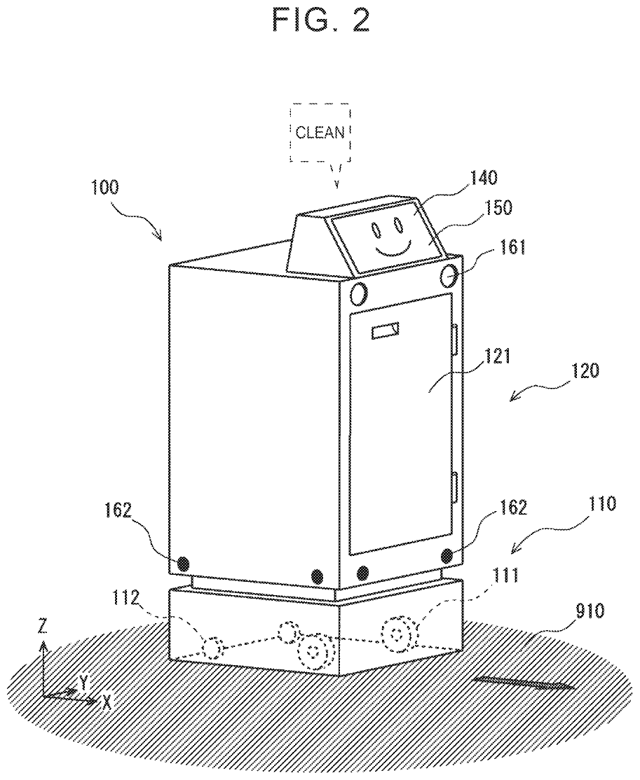

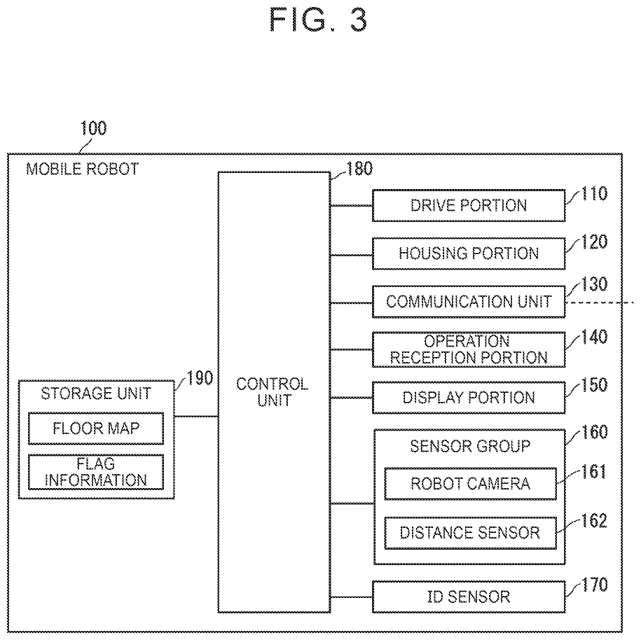

FIG. 2 is a perspective view illustrating the mobile robot 100 according to the first embodiment. FIG. 3 is a block diagram illustrating the mobile robot 100 according to the first embodiment. As shown in FIGS. 2 and 3, the mobile robot 100 includes a drive portion 110, a housing portion 120, a communication unit 130, an operation reception portion 140, a display portion 150, a sensor group 160, an identification (ID) sensor 170, a control unit 180, and a storage unit 190.

As shown in FIG. 2, the mobile robot 100 is a mobile body that moves on the floor surface 910 that is a moving surface. Here, for convenience of explanation of the mobile robot 100, the XYZ orthogonal coordinate axis system is used. The floor surface 910 is the XY-plane, and the upper side is the +Z axis direction.

The drive portion 110 functions as a device for moving the mobile robot 100. The drive portion 110 includes two drive wheels 111 that are in contact with the floor surface 910 and are rotatable independently from each other about one rotation axis that extends in a direction (right-left direction or Y-axis direction in the drawing) perpendicular to a straight direction (front-back direction or X-axis direction in the drawing), and casters 112 in contact with the floor surface 910. The mobile robot 100 moves forward or rearward in a manner such that the drive wheels 111 disposed on the right and left sides are driven at the same rotation speed, and makes a turn by generating a difference in the rotation speed or rotation direction between the right and left drive wheels 111. The drive portion 110 drives the drive wheels 111 in accordance with commands from the control unit 180.

The housing portion 120 is disposed above the drive portion 110 of the mobile robot 100. The housing portion 120 may have a storage chamber door 121. When the storage chamber door 121 is opened, a storage chamber for storing a predetermined transported object is provided inside the housing portion 120. That is, the mobile robot 100 can also be a transportation robot that transports a predetermined object. The housing portion 120 may open and close the storage chamber door 121 in accordance with a command from the control unit 180.

As shown in FIG. 3, the communication unit 130 is an interface that is communicably connected to the outside. The communication unit 130 includes, for example, an antenna and a circuit that modulates or demodulates a signal transmitted through the antenna. The communication unit 130 receives the image data directly from the facility camera 400 or via the access point 500 and the server device 300.

Further, the communication unit 130 may receive information on the destination, information on whether movement is allowed, and the flag information from the server device 300. Further, the communication unit 130 may transmit information related to the state of the mobile robot 100, the position information, the traveling information, the flag information and the like to the server device 300. Further, the communication unit 130 may transmit and receive the position information, the image data, and the flag information to and from another mobile robot 100 directly or via the access point 500 and the server device 300.

The communication unit 130 may periodically transmit a heartbeat signal to the server device 300. The heartbeat signal may include log data indicating the state of the mobile robot 100 in the chronological order. Further, the heartbeat signal may include the identification (ID) of the mobile robot 100 and the ID of a user.

The communication unit 130 connects to the control unit 180, outputs, to the control unit 180, a signal including information transmitted from the facility camera 400 and the server device 300, and transmits, to the server device 300, the signal output from the control unit 180.

The operation reception portion 140 receives an input operation from the user and transmits an operation signal to the control unit 180. As a device for receiving an input operation from the user, the operation reception portion 140 may include, for example, an operation button, a touch panel superimposed on the display portion 150, or the like. The user operates the input operation device described above to turn on and off the power supply, open and close the storage chamber door 121, and the like. In addition, the user may operate the operation reception portion 140 to input the flag information associated with the mobile robot 100 in accordance with the cleanliness of the objects stored in the storage chamber. For example, the user inputs the cleanliness flag, the uncleanliness flag, the general-purpose flag, and the like from the operation reception portion 140.

The display portion 150 is provided, for example, so as to project from the upper surface of the housing portion 120. The display portion 150 is, for example, a display portion including a rectangular liquid crystal panel. The display portion 150 appropriately displays information in accordance with the command from the control unit 180. A touch panel that receives operations from the user may be superimposed on the display portion 150. The display portion 150 may display the flag information associated with the mobile robot 100.

The sensor group 160 includes a sensor that acquires data necessary for the mobile robot 100 to move autonomously. The sensor group 160 includes, for example, a robot camera 161 and a distance sensor 162. The sensor group 160 may include sensors other than the robot camera 161 and the distance sensor 162.

The robot camera 161 is disposed in an upper portion of the housing portion 120 and below the display portion 150, for example. In the robot camera 161, two camera units having the same angle of view may be disposed horizontally separated from each other. With this configuration, the images captured by each camera unit are output to the control unit 180 as the image data.

The distance sensor 162 is disposed, for example, in the lower portion of the housing portion 120. The distance sensor 162 may be disposed in the lower portion of each of a surface on the +X-axis direction side, a surface on the −X-axis direction side, a surface on the +Y-axis direction side, and a surface on the −Y-axis direction side of the housing portion 120. The distance sensor 162 measures the distance of an object around the mobile robot 100. The control unit 180 recognizes the obstacle around the mobile robot 100 by analyzing the image data output by the robot camera 161 and the detection signals output by the distance sensor 162, and measures the distance between the mobile robot 100 and the obstacle.

The ID sensor 170 is provided, for example, in the vicinity of the display portion 150. The ID sensor 170 identifies the ID of the user who operates the mobile robot 100, and detects a unique identifier included in the ID card owned by each user. The ID sensor 170 includes, for example, an antenna for reading information on a wireless tag. The user brings the ID card close to the ID sensor 170 such that the mobile robot 100 is caused to recognize the ID of the user who is the operator.

The control unit 180 is an information processing device including an arithmetic device such as a central processing unit (CPU). The control unit 180 includes hardware provided in the control unit 180 and a program stored in the hardware. That is, processes executed by the control unit 180 are realized by either hardware or software.

The control unit 180 acquires various types of information from each configuration and issues a command to each configuration in accordance with the acquired information. For example, the control unit 180 detects the distance between the mobile robot 100 and the surrounding object from the image data acquired from the robot camera 161 and the information on the object around the mobile robot 100 acquired from the distance sensor 162. Further, the control unit 180 calculates a route to the destination based on the flag information associated with the mobile robot 100 and the flag information associated with the area in the facility 900. Then, the control unit 180 commands the drive portion 110 to move along the calculated route. When executing such a process, the control unit 180 refers to information related to a floor map and the flag information associated with the areas in the facility 900 that are stored in the storage unit 190.

The storage unit 190 includes a non-volatile memory such as a flash memory and a solid state drive (SSD). The storage unit 190 stores a floor map of a facility used by the mobile robot 100 for making autonomous movement. In addition, the storage unit 190 stores the flag information associated with the areas in the facility 900. The storage unit 190 is connected to the control unit 180, and outputs stored information to the control unit 180 in response to a request from the control unit 180.

As shown in FIG. 2, the mobile robot 100 has the +X-axis direction side on which the robot camera 161 is installed as the front. That is, during normal movement, the traveling direction is the +X-axis direction as shown by the arrow.

Various ideas can be adopted for how to define the front of the mobile robot 100. For example, the front can be defined based on how the sensor group 160 for recognizing the surrounding environment is disposed. Specifically, the +X-axis direction side of the housing portion 120 on which the sensor having high recognition ability is disposed or many sensors are disposed can be set as the front. By defining the front as described above, the mobile robot 100 can move while recognizing the surrounding environment more accurately. The mobile robot 100 according to the present embodiment also has the +X-axis direction side on which the robot camera 161 is disposed as the front.

Alternatively, the front can be defined based on how the display portion 150 is disposed. When the display portion 150 displays the face of the character or the like, the surrounding people naturally recognize that the display portion 150 is the front of the mobile robot 100. Therefore, when the display surface side of the display portion 150 is set as the front, there is little discomfort to the surrounding people. The mobile robot 100 according to the present embodiment also has the display surface side of the display portion 150 as the front.

Further, the front may be defined based on a shape of the housing of the mobile robot 100. For example, when the projected shape of the housing portion 120 on the traveling surface is rectangular, it is better to have the short side as the front than the longitudinal side as the front, whereby people who pass each other are not obstructed during moving. That is, depending on the shape of the housing, there is a housing surface that is set as the front when the mobile robot 100 moves normally. The mobile robot 100 according to the present embodiment also has the short side of the rectangular shape as the front. As described above, for the mobile robot 100, the front is defined so as to match some ideas. However, which idea is used to define the front may be determined in consideration of the shape and role of the mobile robot.

### Operation of Mobile Robot

Next, the operation of the mobile robot according to the present embodiment will be described. For example, the user turns on the power of the mobile robot 100. Then, the user inputs a desired task to the operation reception portion 140. When necessary, the ID sensor 170 identifies the ID of the user when the power is turned on or when the user operates the operation reception portion 140.

In order to transport the object as a desired task, the user operates the operation reception portion 140 to open the storage chamber door 121 and store the object in the storage chamber. Then, the user operates the operation reception portion 140 to close the storage chamber door 121. When the object stored in the storage chamber is a clean object, the user associates the mobile robot 100 with the cleanliness flag. Alternatively, the user stores a clean object in the mobile robot 100 linked with the cleanliness flag. For example, the user operates the operation reception portion 140 to associate the mobile robot 100 with the cleanliness flag.

Here, clean objects are, for example, a drug taken by the human body, blood for blood transfusion, food, etc., an unused syringe, an unused injection needle, clothing, etc. that come into contact with the human body. On the other hand, unclean objects are garbage and the like that are disposed of. Further, general-purpose objects are stationery, copy papers, and the like.

When the object stored in the storage chamber is the unclean object, the user associates the mobile robot 100 with the uncleanliness flag. Alternatively, the user stores the unclean object in the mobile robot 100 linked with the uncleanliness flag. For example, the user operates the operation reception portion 140 to associate the mobile robot 100 with the uncleanliness flag.

Further, when the object stored in the storage chamber is the general-purpose object, the user associates the mobile robot 100 with the general-purpose flag. Alternatively, the user stores the general-purpose object in the mobile robot 100 linked with the general-purpose flag. For example, the user operates the operation reception portion 140 to associate the mobile robot 100 with the general-purpose flag.

The association of the cleanliness flag, the uncleanliness flag, and the general-purpose flag is not limited to the operation of the operation reception portion 140 by the user. The mobile robot 100 may determine whether the object is clean, unclean, or general-purpose using the sensor group 160 and associate the object with the corresponding flag. Further, the mobile robot 100 may be associated with the flag based on the flag information transmitted from the server device 300.

Further, the mobile robot 100 is not always associated with any of the cleanliness flag, the uncleanliness flag, and the general-purpose flag. There may be any mobile robot 100 that is not associated with the flag.

Next, the user inputs the destination of the object using the operation reception portion 140. The control unit 180 of the mobile robot 100 searches for a route to the destination using the floor map and the flag information that are stored in the storage unit 190.

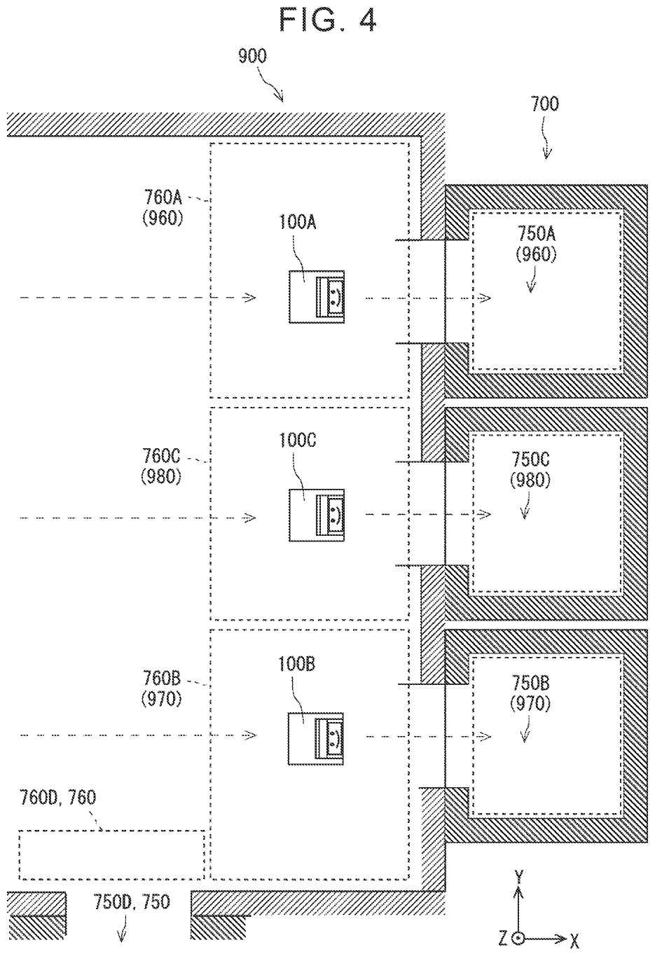

FIG. 4 is a plan view illustrating movement of the mobile robot 100 in the facility 900 according to the first embodiment. As shown in FIG. 4, the facility 900 is provided with an elevator 700. The facility 900 may have a plurality of the elevators 700. The elevators 700 include cars 750A to 750D, respectively. The cars 750A to 750D are box-shaped structures that accommodate people and objects and are lifted and lowered. The facility 900 are provided with elevator halls 760A to 760D adjacent to the elevators 700 on the floor where the cars 750A to 750D of the elevators 700 stop.

The inside of the car 750A and the elevator hall 760A are set as a clean area 960 associated with the cleanliness flag. The inside of the car 750B and the elevator hall 760B are set as an unclean area 970 associated with the uncleanliness flag. The inside of the car 750C and the elevator hall 760C are set as a general-purpose area 980 associated with the general-purpose flag. As described above, the facility 900 includes an area set as the clean area 960 and an area set as the unclean area 970. In addition, the facility 900 may further include an area set in the general-purpose area 980. In some embodiments, the general-purpose area 980 is located between the clean area 960 and the unclean area 970. With this configuration, it is possible to suppress degradation of the cleanliness of the clean area 960 due to the direct contact between the clean area and the unclean area.

Note that, the areas in the facility 900 are not always associated with any of the cleanliness flag, the uncleanliness flag, and the general-purpose flag. The facility 900 may be provided with areas that are not associated with the flags. For example, the facility 900 may have a car 750D and an elevator hall 760D that are not associated with the flag.

When the mobile robot 100 is associated with the cleanliness flag, the mobile robot 100 is allowed to enter the clean area 960 and prohibited from entering the unclean area 970. Therefore, the mobile robot 100A associated with the cleanliness flag is allowed to enter the elevator hall 760A and the car 750A and prohibited from entering the elevator hall 760B and the car 750B. Further, when the mobile robot 100 is associated with the cleanliness flag, the mobile robot 100 may be allowed to enter the general-purpose area 980. Therefore, the mobile robot 100A may be allowed to enter the elevator hall 760C and the car 750C. Further, the mobile robot 100A may be allowed to enter the area that is not associated with the flag. Therefore, the mobile robot 100A may be allowed to enter the car 750D and the elevator hall 760D.

When the mobile robot 100 is associated with the uncleanliness flag, the mobile robot 100 is allowed to enter the unclean area 970, but is prohibited from entering the clean area 960. Therefore, the mobile robot 100B associated with the uncleanliness flag is allowed to enter the elevator hall 760B and the car 750B and prohibited from entering the elevator hall 760A and the car 750A. Further, when the mobile robot 100 is associated with the uncleanliness flag, the mobile robot 100 may be allowed to enter the general-purpose area 980. Therefore, the mobile robot 100B may be allowed to enter the elevator hall 760C and the car 750C. Further, the mobile robot 100B may be allowed to enter the area that is not associated with the flag. Therefore, the mobile robot 100B may be allowed to enter the car 750D and the elevator hall 760D.

When the mobile robot 100 is associated with the general-purpose flag, the mobile robot 100 is allowed to enter the general-purpose area 980. In addition, the mobile robot 100 may be allowed to enter the clean area 960 and allowed to enter the unclean area 970. In this case, the mobile robot 100C associated with the general-purpose flag is allowed to enter the elevator hall 760C and the car 750C, and is allowed to enter the elevator halls 760A and 760B, and the cars 750A and 750B. Further, the mobile robot 100C may be allowed to enter the area that is not associated with the flag. Therefore, the mobile robot 100C may be allowed to enter the car 750D and the elevator hall 760D. Note that, the mobile robot 100 may be set such that the mobile robot 100 is prohibited from entering the clean area 960 and prohibited from entering the unclean area 970 when the mobile robot 100 is associated with the general-purpose flag.

The mobile robot 100 searches for a route to move based on the rule of entry to the clean area 960 and the unclean area 970. The mobile robot 100 moves in the facility 900 based on the rule of entry to the clean area 960 and the unclean area 970.

When the mobile robot 100 is associated with the cleanliness flag, the mobile robot 100 is prohibited from entering the cars 750C and 750D of the elevators 700 (hereinafter the cars 750C and 750D are collectively referred to as the car 750) together with another mobile robot 100B associated with the uncleanliness flag. For example, when the mobile robot 100A associated with the cleanliness flag is placed in the car 750, the other mobile robot 100B associated with the uncleanliness flag is prohibited from entering the same car 750. Further, when the mobile robot 100B associated with the uncleanliness flag is placed in the car 750, another mobile robot 100A associated with the cleanliness flag is prohibited from entering the same car 750.

The car 750 in which the mobile robot 100A associated with the cleanliness flag has been placed is designated as the clean area 960 for a predetermined period. Therefore, the mobile robot 100B associated with the uncleanliness flag cannot enter the car 750 in which the mobile robot 100A has been placed for the predetermined period. On the other hand, the car 750 in which the mobile robot 100B associated with the uncleanliness flag has been placed is set as the unclean area 970 for a predetermined period. Therefore, the mobile robot 100A associated with the cleanliness flag cannot enter the car 750 in which the mobile robot 100B has been placed for the predetermined period.

In addition, a predetermined area in the facility 900 may be set as the clean area 960 or the unclean area 970 for a predetermined time. For example, the car 750 may be set as the clean area 960 for a predetermined time, and the car 750 may be set as the unclean area 970 for a predetermined time thereafter.

The flag information that the car 750 is set as the clean area 960 or the unclean area 970 may be transmitted and received directly between the mobile robots 100 or via the server device 300 and the access point 500. The predetermined period may be, for example, one hour or one day. With this configuration, the car 750 can be dedicated to the mobile robot 100 associated with the cleanliness flag or the uncleanliness flag for a predetermined period, whereby the cleanliness can be maintained.

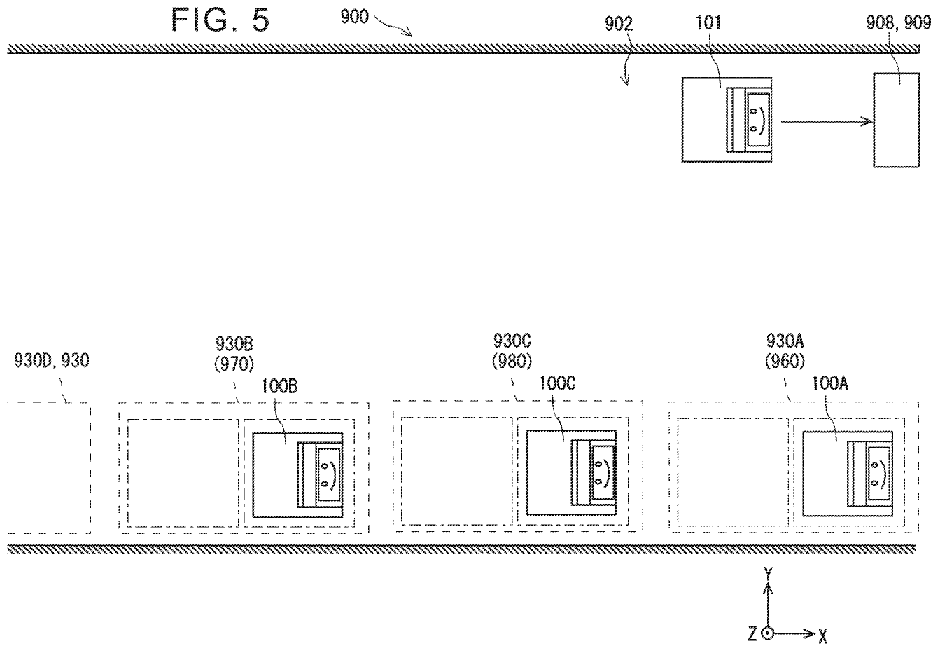

FIG. 5 is a plan view illustrating movement of the mobile robot 100 in the facility 900 according to the first embodiment. As shown in FIG. 5, the facility 900 includes standby areas 930A to 930D. The standby areas 930A to 930D are places where the mobile robot 100 stops and waits. Specifically, for example, the standby areas 930A to 930D are places where, among the mobile robots 100, the other mobile robots 100A to 100C stop and wait until a preceding mobile robot 101 completes transportation to transportation destination 908 or passing of a waypoint 909 in the facility 900. A plurality of the standby areas 930A to 930D may be provided in the facility 900. The standby areas 930A to 930D are provided so as not to interfere with the movement of people and the other mobile robots 100, for example, in an aisle 902.

For example, the standby area 930A is set as the clean area 960 associated with the cleanliness flag. The standby area 930B is set as the unclean area 970 associated with the uncleanliness flag. The standby area 930C is set as the general-purpose area 980 associated with the general-purpose flag. As described above, the facility 900 may include the standby area 930A set as the clean area 960, the standby area 930B set as the unclean area 970, and the standby area 930C set as the general-purpose area 980. Further, the facility 900 may include the standby area 930D that is not associated with the flag.

The mobile robot 100A associated with the cleanliness flag is allowed to enter the standby area 930A and prohibited from entering the standby area 930B. The mobile robot 100A may be allowed to enter the standby area 930C or may be allowed to enter the standby area 930D.

The mobile robot 100B associated with the uncleanliness flag is allowed to enter the standby area 930B and prohibited from entering the standby area 930A. The mobile robot 100B may be allowed to enter the standby area 930C or may be allowed to enter the standby area 930D.

The mobile robot 100C associated with the general-purpose flag is allowed to enter the standby area 930C. In addition, entry of the mobile robot 100C into the standby areas 930A and 930B may be allowed. Further, the mobile robot 100C may be allowed to enter the standby area 930D.

When the mobile robot 100 is associated with the cleanliness flag, the mobile robot 100 is prohibited from waiting in the same standby area as the other mobile robots 100B associated with the uncleanliness flag. For example, when the mobile robot 100A associated with the cleanliness flag is waiting in the standby area 930C and the standby area 930D (hereinafter, the standby area 930C and the standby area 930D are collectively referred to as the standby area 930), the other mobile robot 100B associated with the uncleanliness flag is prohibited from waiting in the same standby area 930. Further, when the mobile robot 100B associated with the uncleanliness flag is waiting in the standby area 930, the other mobile robot 100A associated with the cleanliness flag is prohibited from waiting in the same standby area 930.

The standby area 930 where the mobile robot 100A associated with the cleanliness flag has waited is designated as the clean area 960 for a predetermined period. Therefore, the mobile robot 100B associated with the uncleanliness flag cannot wait in the standby area 930 for the predetermined period. Further, the standby area 930 where the mobile robot 100B associated with the uncleanliness flag has waited is set as the unclean area 970 for a predetermined period. Therefore, the mobile robot 100A associated with the cleanliness flag cannot wait in the standby area 930 for the predetermined period.

Further, the standby area 930 may be set as the clean area 960 for a predetermined time, and may be set as the unclean area 970 for a predetermined time thereafter.

When the mobile robot 100A is associated with the cleanliness flag, the mobile robot 100A moves away from the other mobile robot 100B associated with the uncleanliness flag by a predetermined distance or more. Similarly, when the mobile robot 100B is associated with the uncleanliness flag, the mobile robot 100B moves away from the other mobile robot 100A associated with the cleanliness flag by a predetermined distance or more. With this configuration, cleanliness can be maintained.

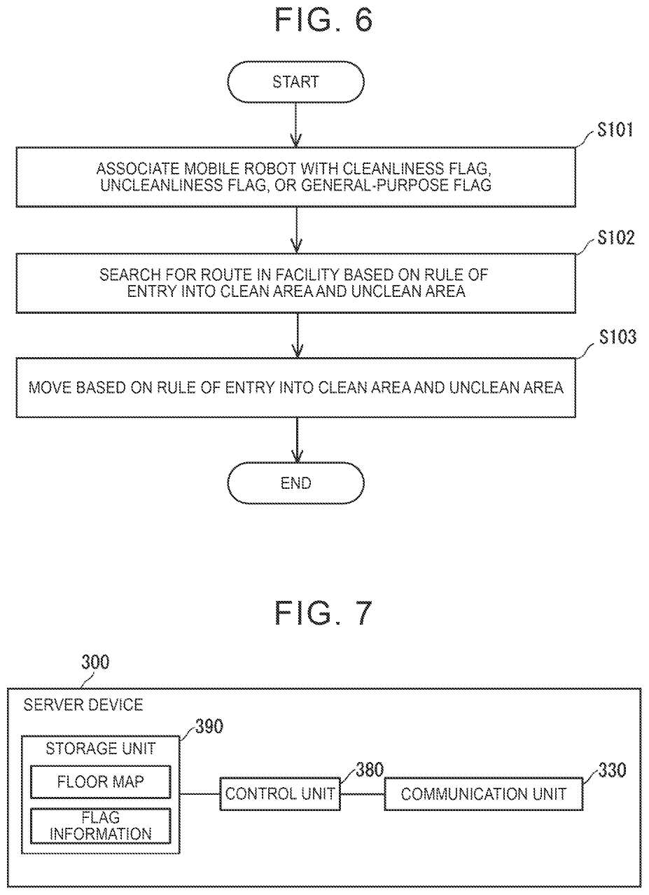

The operation of the mobile robot 100 described above will be described with reference to a flowchart. FIG. 6 is a flowchart illustrating an autonomous mobile method for the mobile robot in the facility 900 according to the first embodiment.

As shown in step S101 of FIG. 6, the mobile robot 100 is associated with the cleanliness flag, the uncleanliness flag, or the general-purpose flag. For example, the user inputs the cleanliness flag using the operation reception portion 140 when the user stores a clean object in the storage chamber. With this process, the control unit 180 associates the mobile robot 100 with the cleanliness flag. On the other hand, the user inputs the uncleanliness flag using the operation reception portion 140 when the user stores the unclean object in the storage chamber. With this process, the control unit 180 associates the mobile robot 100 with the uncleanliness flag. Further, the user inputs the general-purpose flag using the operation reception portion 140 when the user stores a general-purpose object in the storage chamber. With this process, the control unit 180 associates the mobile robot 100 with the general-purpose flag.

Similarly, the user may input the flag information in advance for the areas in the facility 900. With this process, the control unit 180 sets the clean area 960 associated with the cleanliness flag, the unclean area 970 associated with the uncleanliness flag, and the general-purpose area 980 associated with the general-purpose flag. The input of the flag information is not limited to the input of the user, and may be the input from the sensor group 160 of the mobile robot 100 or the input from the server device 300. Further, there may be a mobile robot 100 that is not associated with the flag, or there may be an area that is not associated with the flag.

Next, as shown in step S102, the control unit 180 of the mobile robot 100 searches for a route in the facility 900 based on the rule of entry to the clean area 960 and the unclean area 970. According to the rule, for example, when the mobile robot 100 is associated with the cleanliness flag, the mobile robot 100 is allowed to enter the clean area 960 and prohibited from entering the unclean area 970. Further, according to the rule, when the mobile robot 100 is associated with the uncleanliness flag, the mobile robot 100 is allowed to enter the unclean area 970 and prohibited from entering the clean area 960. Further, when the mobile robot 100 is associated with the general-purpose flag, the mobile robot 100 may be allowed to enter the clean area 960 and is also allowed to enter the unclean area 970.

When a route along which the mobile robot 100 moves based on the rule of entry to the clean area 960 and the unclean area 970 is searched, the car 750 in which the mobile robot 100A associated with the cleanliness flag has been placed and the standby area 930 where the mobile robot 100 associated with the cleanliness flag has waited may be set as the clean area 960 for a predetermined time. Similarly, the car 750 in which the mobile robot 100B associated with the uncleanliness flag has been placed and the standby area 930 where the mobile robot 100B has waited may be set as the unclean area 970 for a predetermined period.

In addition, predetermined areas in the facility 900, such as the car 750 and the standby area 930, may be set as the clean area 960 or the unclean area 970 for a predetermined time.

Next, as shown in step S103, the mobile robot 100 moves based on the rule of entry to the clean area 960 and the unclean area 970. In the case where the mobile robot 100 is associated with the cleanliness flag when the mobile robot 100 moves based the rule, the mobile robot 100 is prohibited from entering the same car 750 and the same standby area 930 as the other mobile robot 100B associated with the uncleanliness flag, among the cars 750 of the elevators 700 and the standby areas 930. Further, in the case where the mobile robot 100 is associated with the uncleanliness flag, the mobile robot 100 is prohibited from entering the same car 750 and the same standby area 930 as the other mobile robot 100A associated with the cleanliness flag, among the cars 750 of the elevators 700 and the standby areas 930.

For example, the mobile robot 100A associated with the cleanliness flag may wait for the other car 750A or 750 so as not to be placed with the mobile robot 100B associated with the uncleanliness flag, or may search for another route.

Further, in the case where the mobile robot 100 is associated with the cleanliness flag when the mobile robot moves based on the rule, the mobile robot 100 moves away from the other mobile robot 100B associated with the uncleanliness flag by a predetermined distance or more. In the case where the mobile robot 100 is associated with the uncleanliness flag, the mobile robot 100 moves away from the other mobile robot 100A associated with the cleanliness flag by a predetermined distance or more.

Next, the effect of the present embodiment will be described. The mobile robot 100 according to the present embodiment moves in the facility 900 based on the rule of entry to the clean area 960 and the unclean area 970. Therefore, it is possible to suppress the approach between the mobile robot 100 associated with the cleanliness flag and the mobile robot 100 associated with the uncleanliness flag. This makes it possible to improve the viewpoint of health and hygiene.

For example, in the car 750 of the elevator 700 and in the standby area 930, the mobile robot 100A associated with the cleanliness flag is prohibited from being placed with the other mobile robot 100B associated with the uncleanliness flag. This makes it possible to improve the viewpoint of health and hygiene in the car 750 of the elevator 700 and in the standby area 930.

Further, the car 750 and the standby area 930 used by the mobile robot 100A associated with the cleanliness flag are set as the clean area 960 for a predetermined period. With this configuration, the viewpoint of health and hygiene of the clean area 960 in the car 750 and in the standby area 930 can be improved.

### Second Embodiment

Next, an autonomous mobile system according to a second embodiment will be described. The autonomous mobile system according to the present embodiment is a system that controls an autonomous mobile device that autonomously moves in the predetermined facility 900. The autonomous mobile system will be described separately in “Configuration of Autonomous Mobile System” and “Operation of Autonomous Mobile System”.

### Configuration of Autonomous Mobile System

The autonomous mobile system includes the mobile robot 100. The autonomous mobile system may include a plurality of the mobile robots 100. Further, the autonomous mobile system may include the server device 300 in addition to the mobile robot 100.

### Mobile Robot

The configuration of the mobile robot 100 according to the present embodiment is the same as that of the above-described first embodiment. The mobile robot 100 according to the present embodiment may cause the server device 300 to execute some of the functions of the mobile robot 100 according to the first embodiment.

For example, the server device 300 may be caused to execute association of the mobile robots 100 with the cleanliness flag, the uncleanliness flag, and the general-purpose flag. Further, the server device 300 may be caused to execute association of the areas in the facility 900 with the cleanliness flag, the uncleanliness flag, and the general-purpose flag. Further, the server device 300 may be caused to search for a route in the facility 900 based on the rule of entry to the clean area 960 and the unclean area 970.

### Server Device

The server device 300 is, for example, a computer having a communication function. The server device 300 may be installed at any place as long as the server device 300 can communicate with each configuration of the autonomous mobile system. The server device 300 transmits and receives traveling information to and from the mobile robot 100.

FIG. 7 is a block diagram illustrating a server device according to the second embodiment. As shown in FIG. 7, the server device 300 includes a communication unit 330, a control unit 380, and a storage unit 390.

The communication unit 330 communicates with the mobile robot 100 individually. The communication unit 330 outputs a signal received from each configuration to the control unit 380. Further, the communication unit 330 appropriately transmits a signal output from the control unit 380 to each configuration. The communication unit 330 may include a router device for performing communication between the server device 300 and a plurality of configurations. The communication unit 330 may have a plurality of communication units each of which is different for each component to communicate with the communication unit 330 in order to communicate with the server device 300 and the configurations. The communication unit 330 may be communicably connected to each configuration via an intranet line or the Internet line.

The control unit 380 is configured by an arithmetic device such as a CPU and executes various types of information processing. The control unit 380 may associate the mobile robots 100 and the areas in the facility 900 with the cleanliness flag, the uncleanliness flag, and the general-purpose flag. In addition, the control unit 380 may search for a route in the facility 900 based on the rule of entry to the clean area 960 and the unclean area 970.

The storage unit 390 includes a non-volatile memory such as a flash memory and an SSD. The storage unit 390 stores the floor map of the facility used by the mobile robot 100 for autonomously moving. In addition, the storage unit 390 stores the flag information associated with the areas in the facility 900. The storage unit 390 is connected to the control unit 380, and outputs stored information to the control unit 380 in response to a request from the control unit 380.

### Operation of Autonomous Mobile System

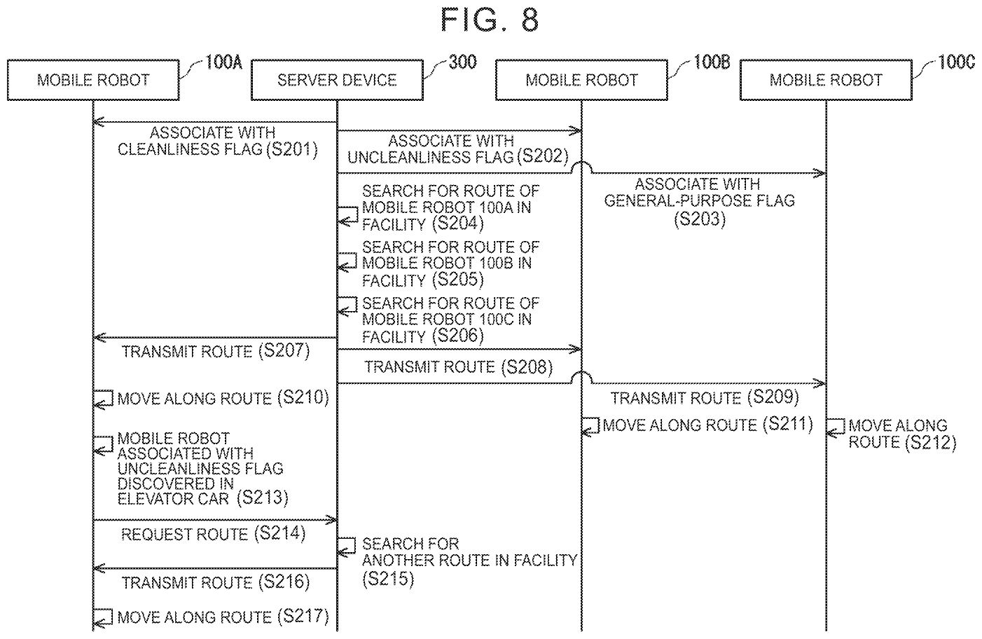

Next, the operation of the autonomous mobile system will be described. FIG. 8 is a sequence diagram illustrating the operation of the autonomous mobile system according to the second embodiment.

As shown in steps S201 to S203 of FIG. 8, the server device 300 associates the mobile robots 100A to 100C with the cleanliness flag, the uncleanliness flag, and the general-purpose flag, respectively. Further, the server device 300 may set the clean area 960 associated with the cleanliness flag, the unclean area 970 associated with the uncleanliness flag, and the general-purpose area 980 associated with the general-purpose flag for the areas in the facility 900. Note that, there may be a mobile robot 100 and an area that are not associated with the cleanliness flag, the uncleanliness flag, and the general-purpose flag.

Next, as shown in steps S204 to S206, the server device 300 searches for a route for each of the mobile robots 100A to 100C to move in the facility 900 based on the rule of entry to the clean area 960 and the unclean area 970. Note that, when the server device 300 searches for a route, the server device 300 may set the car 750 in which the mobile robot 100A associated with the cleanliness flag has been placed and the standby area 930 where the mobile robot 100A associated with the cleanliness flag has waited as the clean area 960 for a predetermined period. Note that, when the server device 300 searches for a route, the server device 300 may set the car 750 in which the mobile robot 100B associated with the uncleanliness flag has been placed and the standby area 930 where the mobile robot 100B associated with the uncleanliness flag has waited as the unclean area 970 for a predetermined period.

Next, as shown in steps S207 to S209, the server device 300 transmits the searched route to the mobile robots 100A to 100C.

Next, as shown in steps S210 to S212, each of the mobile robots 100A to 100C moves along the searched route based on the rule of entry to the clean area 960 and the unclean area 970. As described above, the mobile robots 100A to 100C move in the facility 900.

For example, when the mobile robot 100A moves based on the rule, the mobile robot 100A discovers the mobile robot 100B associated with the uncleanliness flag in the car 750 of the elevator 700 on the path as shown in step S213. In this case, the mobile robot 100A cannot enter the car 750 in which the mobile robot 100B is placed. Therefore, as shown in step S214, the mobile robot 100A requests the server device 300 to search for another route in the facility 900. Therefore, as shown in step S215, the server device 300 searches for another route for the mobile robot 100A in the facility 900. Then, as shown in step S216, the server device 300 transmits the route to the mobile robot 100A. In response to this, the mobile robot 100A moves along the new route as shown in step S217.

According to the autonomous mobile system of the present embodiment, the server device 300 can carry out some functions of the mobile robot 100. For example, the server device 300 executes setting of the clean area 960, the unclean area 970, and the general-purpose area 980 and association of the mobile robot 100. Therefore, the load on the mobile robot 100 can be reduced, and the processing speed of the mobile robot 100 can also be improved.

Moreover, the movement of the mobile robots 100 can be controlled, whereby the movement efficiency can be improved. Other configurations, operations and effects are included in the description of the first embodiment.

The present disclosure is not limited to the above embodiment, and can be appropriately modified without departing from the spirit. For example, a combination of the configurations of the first and second embodiments is also included in the scope of the technical idea of the present embodiment. In addition, the autonomous mobile method and the autonomous mobile program shown below are also included in the scope of the technical idea of the present embodiment.

### APPENDIX 1

An autonomous mobile method for an autonomous mobile device that autonomously moves in a facility provided with an area set as a clean area and an area set as an unclean area includes: a step of associating the autonomous mobile device with a cleanliness flag or an uncleanliness flag; a step of searching for a route along which the autonomous mobile device moves based on a rule of entry to the clean area and the unclean area, the rule being a rule in which, when the autonomous mobile device is associated with the cleanliness flag, the autonomous mobile device is allowed to enter the clean area and prohibited from entering the unclean area, and when the autonomous mobile device is associated with the uncleanliness flag, the autonomous mobile device is allowed to enter the unclean area and prohibited from entering the clean area; and a step of moving based on the rule.

### APPENDIX 2

In the autonomous mobile method according to Appendix 1, the facility is provided with an elevator; and in the step of moving based on the rule, when the autonomous mobile device is associated with the cleanliness flag, the autonomous mobile device is prohibited from being placed in a car of the elevator with another autonomous mobile device associated with the uncleanliness flag.

### APPENDIX 3

In the autonomous mobile method according to Appendix 1, the facility is provided with an elevator; and in the step of searching for the route, an inside of the car of the elevator in which the autonomous mobile device associated with the cleanliness flag has been placed is set as the clean area for a predetermined period.

### APPENDIX 4

In the autonomous mobile method according to Appendix 1, the facility is provided with a standby area where the autonomous mobile device stops and waits, and in the step of moving based on the rule, when the autonomous mobile device is associated with the cleanliness flag, the autonomous mobile device is prohibited from waiting in the same standby area as another autonomous mobile device associated with the uncleanliness flag.

### APPENDIX 5

In the autonomous mobile method according to Appendix 1, the facility is provided with a standby area where the autonomous mobile device stops and waits, and in the step of searching for the route, the standby area where the autonomous mobile device associated with the cleanliness flag has waited is set as the clean area for a predetermined period.

### APPENDIX 6

In the autonomous mobile method according to Appendix 1, in the step of moving based on the rule, when the autonomous mobile device is associated with the cleanliness flag, the autonomous mobile device moves away from another autonomous mobile device associated with the uncleanliness flag by a predetermined distance or more.

### APPENDIX 7

In the autonomous mobile method according to Appendix 1, in the step of searching for the route, when the autonomous mobile device is associated with the general-purpose flag, the autonomous mobile device is allowed to enter the clean area and also allowed to enter the unclean area.

### APPENDIX 8

In the autonomous mobile method according to Appendix 1, in the step of searching for the route, a predetermined area in the facility is set as the clean area or the unclean area for a predetermined time.

### APPENDIX 9

An autonomous mobile program for an autonomous mobile device that autonomously moves in a facility provided with an area set as a clean area and an area set as an unclean area, the autonomous mobile program causing a computer to: associate the autonomous mobile device with a cleanliness flag or an uncleanliness flag; search a route along which the autonomous mobile device moves based on a rule of entry to the clean area and the unclean area, the rule being a rule in which, when the autonomous mobile device is associated with the cleanliness flag, the autonomous mobile device is allowed to enter the clean area and prohibited from entering the unclean area, and when the autonomous mobile device is associated with the uncleanliness flag, the autonomous mobile device is allowed to enter the unclean area and prohibited from entering the clean area; and cause the autonomous mobile device to move based on the rule.

### APPENDIX 10

In the autonomous mobile program according to Appendix 9, the facility is provided with an elevator; and the autonomous mobile program causes the computer to prohibit the autonomous mobile device from being placed in a car of the elevator with another autonomous mobile device associated with the uncleanliness flag when the autonomous mobile device associated with the cleanliness flag is caused to move based on the rule.

### APPENDIX 11

In the autonomous mobile program according to Appendix 9, the facility is provided with an elevator; and the autonomous mobile program causes the computer to set an inside of a car of the elevator in which the autonomous mobile device associated with the cleanliness flag has been placed as the clean area for a predetermined period when the route is searched for.

### APPENDIX 12

In the autonomous mobile program according to Appendix 9, the facility is provided with a standby area where the autonomous mobile device stops and waits, and the autonomous mobile program causes the computer to prohibit the autonomous mobile device from waiting in the same standby area where another autonomous mobile device associated with the uncleanliness flag waits when the autonomous mobile device associated with the cleanliness flag is caused to move based on the rule.

### APPENDIX 13

In the autonomous mobile program according to Appendix 9, the facility is provided with a standby area where the autonomous mobile device stops and waits, and the autonomous mobile program causes the computer to set the standby area where the autonomous mobile device associated with the cleanliness flag has waited as the clean area for a predetermined period when the route is searched for.

### APPENDIX 14

The autonomous mobile program according to Appendix 9, causing the computer to cause the autonomous mobile device to move away from another autonomous mobile device associated with the uncleanliness flag by a predetermined distance or more when the autonomous mobile device associated with the cleanliness flag is caused to move based on the rule.

### APPENDIX 15

The autonomous mobile program according to Appendix 9, causing the computer to allow the autonomous mobile device to enter the clean area and to enter the unclean area when the autonomous mobile device is associated with a general-purpose flag.

### APPENDIX 16

The autonomous mobile program according to Appendix 9, causing the computer to set a predetermined area in the facility as the clean area or the unclean area for a predetermined time when the route is searched for.

What is claimed is:

1. An autonomous mobile system that autonomously moves in a facility provided with an area set as a clean area and an area set as an unclean area, wherein:
when the autonomous mobile system is associated with a cleanliness flag, the autonomous mobile system is allowed to enter the clean area and prohibited from entering the unclean area;
when the autonomous mobile system is associated with an uncleanliness flag, the autonomous mobile system is allowed to enter the unclean area and prohibited from entering the clean area; and
the autonomous mobile system searches for a route based on a rule of entry to the clean area and the unclean area, and moves based on the rule.

2. The autonomous mobile system according to claim 1, wherein:
the facility is provided with an elevator; and
when the autonomous mobile system is associated with the cleanliness flag, the autonomous mobile system is prohibited from being placed in a car of the elevator with another autonomous mobile system associated with the uncleanliness flag.

3. The autonomous mobile system according to claim 1, wherein:
the facility is provided with an elevator; and
an inside of a car of the elevator in which the autonomous mobile system associated with the cleanliness flag has been placed is set as the clean area for a predetermined period.

4. The autonomous mobile system according to claim 1, wherein:
the facility is provided with a standby area where the autonomous mobile system stops and waits; and
when the autonomous mobile system is associated with the cleanliness flag, the autonomous mobile system is prohibited from waiting in the same standby area as another autonomous mobile system associated with the uncleanliness flag.

5. The autonomous mobile system according to claim 1, wherein:
the facility is provided with a standby area where the autonomous mobile system stops and waits; and
the standby area where the autonomous mobile system associated with the cleanliness flag has waited is set as the clean area for a predetermined period.

6. The autonomous mobile system according to claim 1, wherein when the autonomous mobile system is associated with the cleanliness flag, the autonomous mobile system moves away from another autonomous mobile system associated with the uncleanliness flag by a predetermined distance or more.

7. The autonomous mobile system according to claim 1, wherein when the autonomous mobile system is associated with a general-purpose flag, the autonomous mobile system is allowed to enter the clean area and allowed to enter the unclean area.

8. The autonomous mobile system according to claim 1, wherein a predetermined area in the facility is set as the clean area or the unclean area for a predetermined time.

9. An autonomous mobile system, comprising:
an autonomous mobile device that autonomously moves in a facility provided with an area set as a clean area and an area set as an unclean area; and
a server device that transmits and receives traveling information to and from the autonomous mobile device, wherein:
the autonomous mobile device is allowed to enter the clean area and prohibited from entering the unclean area when the autonomous mobile device is associated with a cleanliness flag, and is allowed to enter the unclean area and prohibited from entering the clean area when the autonomous mobile device is associated with an uncleanliness flag;
the server device searches for a route along which the autonomous mobile device moves, based on a rule of entry to the clean area and the unclean area; and
the autonomous mobile device moves based on the rule.

10. The autonomous mobile system according to claim 9, wherein:
the facility is provided with an elevator; and
when the autonomous mobile device is associated with the cleanliness flag, the autonomous mobile device is prohibited from being placed in a car of the elevator with another autonomous mobile device associated with the uncleanliness flag.

11. The autonomous mobile system according to claim 9, wherein:
the facility is provided with an elevator; and
the server device sets an inside of a car of the elevator in which the autonomous mobile device associated with the cleanliness flag has been placed as the clean area for a predetermined period.

12. The autonomous mobile system according to claim 9, wherein:
the facility is provided with a standby area where the autonomous mobile device stops and waits; and
when the autonomous mobile device is associated with the cleanliness flag, the autonomous mobile device is prohibited from waiting in the same standby area as another autonomous mobile device associated with the uncleanliness flag.

13. The autonomous mobile system according to claim 9, wherein:
the facility is provided with a standby area where the autonomous mobile device stops and waits; and
the server device sets the standby area where the autonomous mobile device associated with the cleanliness flag has waited as the clean area for a predetermined period.

14. The autonomous mobile system according to claim 9, wherein the server device causes the autonomous mobile device associated with the cleanliness flag to move away from another autonomous mobile device associated with the uncleanliness flag by a predetermined distance or more.

15. The autonomous mobile system according to claim 9, wherein when the autonomous mobile device is associated with a general-purpose flag, the autonomous mobile device is allowed to enter the clean area and allowed to enter the unclean area.

16. The autonomous mobile system according to claim 9, wherein the server device sets a predetermined area in the facility as the clean area or the unclean area for a predetermined time.

17. An autonomous mobile method for an autonomous mobile device that autonomously moves in a facility provided with an area set as a clean area and an area set as an unclean area, the autonomous mobile method comprising:
a step of associating the autonomous mobile device with a cleanliness flag or an uncleanliness flag;
a step of searching for a route along which the autonomous mobile device moves based on a rule of entry to the clean area and the unclean area, the rule being a rule in which, when the autonomous mobile device is associated with the cleanliness flag, the autonomous mobile device is allowed to enter the clean area and prohibited from entering the unclean area, and when the autonomous mobile device is associated with the uncleanliness flag, the autonomous mobile device is allowed to enter the unclean area and prohibited from entering the clean area; and
a step of moving based on the rule.

18. An autonomous mobile program for an autonomous mobile device that autonomously moves in a facility provided with an area set as a clean area and an area set as an unclean area, the autonomous mobile program causing a computer to:
associate the autonomous mobile device with a cleanliness flag or an uncleanliness flag;
search a route along which the autonomous mobile device moves based on a rule of entry to the clean area and the unclean area, the rule being a rule in which, when the autonomous mobile device is associated with the cleanliness flag, the autonomous mobile device is allowed to enter the clean area and prohibited from entering the unclean area, and when the autonomous mobile device is associated with the uncleanliness flag, the autonomous mobile device is allowed to enter the unclean area and prohibited from entering the clean area; and
cause the autonomous mobile device to move based on the rule.
